(19) United States
(12) Patent Application Publication
(10) Pub. No.: US 2026/0298300 A1
(43) Pub. Date: Oct. 1, 2026

(54) NON-RECIRCULATING BALL-NUT DRIVE FOR ELECTROMECHANICAL BRAKE

(71) Applicant: ZF Active Safety US Inc., Livonia, MI (US)

(72) Inventors: Galus Chelaidite, South Lyon, MI (US); Kraig E. Gerber, Plymouth Township, MI (US); Changming Wu, Plymouth, MI (US)

(21) Appl. No.: 19/096,874

(22) Filed: Apr. 1, 2025

(51) Int. Cl. F16D 65/18; B60T 13/74; F16D 125/40; F16D 127/02

(52) U.S. Cl. CPC F16D 65/18; B60T 13/746; F16D 2125/40; F16D 2127/02

(57) ABSTRACT

A ball-nut assembly for an actuator assembly of a vehicle brake includes a spindle rotatable about an axis and having an exterior track winding extending around the spindle and an inner recess extending axially into the spindle. A piston integrated with a nut includes an interior track winding and is positioned over the spindle so as to be movable along the axis in response to rotation of the spindle for applying the vehicle brake. A cage is provided between the track windings and includes openings for receiving bearing balls sized to at least one of roll and slip interference free within the track windings. A cage return mechanism is provided in the inner recess of the spindle. The cage moves axially and rotationally from a start position in a first direction with the nut relative to the spindle in response to brake application to load the cage return mechanism, and in response to releasing the brake the cage return mechanism unloads to automatically move the cage in an opposite second direction back to the start position.

### TECHNICAL FIELD

The present invention relates generally to electromechanical brakes and, in particular, relates to a ball-nut drive for an actuator assembly of the electromechanical brake.

### BACKGROUND

Most vehicles are equipped with a brake system for slowing or stopping movement of the vehicle in a controlled manner. A typical brake system for a modern automobile or light truck includes a disc brake assembly for each of the front wheels as well as a disc brake assembly for each of the rear wheels. The brake assemblies are actuated by hydraulic or pneumatic pressure generated when an operator of the vehicle depresses a brake pedal. A future brake system replaces the hydraulic or pneumatic brake system with an electromechanical brake system that uses an electrical power source to actuate subassemblies including an electric motor, a transmission and a ball nut assembly can be used to actuate the service brake during typical or emergency events as well as to actuate the parking brake. In some instances, the bearings in the ball nut assembly are recirculated in an endless loop during operation of the electromechanical brake system.

### SUMMARY OF THE INVENTION

In one example, a ball-screw drive for an actuator assembly of a vehicle brake includes a spindle rotatable about an axis and having an exterior track winding extending around the spindle and an inner recess extending axially into the spindle. A ball-nut assembly for an actuator assembly of a vehicle brake includes a spindle rotatable about an axis and having an exterior track winding extending around the spindle and an inner recess extending axially into the spindle. A piston integrated with a nut includes an interior track winding and is positioned over the spindle so as to be movable along the axis in response to rotation of the spindle for applying the vehicle brake. A cage is provided between the track windings and includes openings for receiving bearing balls sized to at least one of roll and slip interference free within the track windings. A cage return mechanism is provided in the inner recess of the spindle. The cage moves axially and rotationally from a start position in a first direction with the nut relative to the spindle in response to brake application to load the cage return mechanism, and in response to releasing the brake the cage return mechanism unloads to automatically move the cage in an opposite second direction back to the start position.

In another example, a ball-screw drive for an actuator assembly of a vehicle brake includes a spindle rotatable about an axis and having an exterior track winding extending around the spindle and an inner recess extending axially into the spindle. A nut includes an interior track winding and is positioned over the spindle so as to be movable along the axis in response to rotation of the spindle for applying the vehicle brake. A cage between the track windings and including openings for receiving bearings configured to roll within the track windings. A cage return mechanism is provided in the inner recess of the spindle and includes an end cap provided in the inner recess of the spindle. A biasing member biases the end cap towards the spindle. An axle is threaded into the spindle for coupling the end cap and the biasing member to the spindle and includes features that allow pre-load adjustment on the biasing member. The cage moves axially from a start position in a first direction with the nut relative to the spindle in response to brake application to load the biasing member. In response to stopping the brake application the biasing member unloads to automatically move the cage in an opposite second direction back to the start position.

In another aspect, taken alone or in combination with any other aspect, the cage return mechanism includes an end cap provided in the inner recess of the spindle. A biasing member biases the end cap towards the spindle. A thrust bearing allows generally free rotation of the end cap. An axle couples the end cap and the biasing member to the spindle. In response to brake application the cage moves the end cap in the first direction against the biasing force of the biasing member, and in response to releasing the brake the biasing member automatically moves the end cap in the second direction to return the cage to the start position.

In another aspect, taken alone or in combination with any other aspect, the biasing member is a compression spring.

In another aspect, taken alone or in combination with any other aspect, the biasing member is a torsion spring.

In another aspect, taken alone or in combination with any other aspect, the cage return mechanism further includes a support member fixed to the axle and receiving a first end of the torsion spring. A bearing is movable with the end cap relative to the axle and receiving a second end of the torsion spring.

In another aspect, taken alone or in combination with any other aspect, the axle is threaded into the spindle and the biasing member encircles the axle.

In another aspect, taken alone or in combination with any other aspect, the end cap includes a flange that interfaces with a flange on the cage to prevent relative rotation therebetween during brake application.

In another aspect, taken alone or in combination with any other aspect, the flange on the cage is frustoconical.

In another aspect, taken alone or in combination with any other aspect, the end cap includes a base provided in the inner recess and a flange extending radially outward to an end surface of the spindle for engaging the cage.

In another aspect, taken alone or in combination with any other aspect, the bearings do not recirculate within the track windings.

In another aspect, taken alone or in combination with any other aspect, the nut forms a brake piston.

Other objects and advantages and a fuller understanding of the invention will be had from the following detailed description and the accompanying drawings.

### BRIEF DESCRIPTION OF DRAWINGS

FIG. 1A is perspective view of an actuator assembly having an example spindle drive in accordance with the present invention.

FIG. 1B is a section view of a portion of the actuator assembly.

FIG. 2A is an exploded view of an example non-recirculating spindle drive of the actuator assembly of FIG. 1.

FIG. 2B is a section view of the spindle drive of FIG. 2A.

FIG. 3 is a front view of a roller cage for the spindle drive.

FIG. 4 is an exploded view of a cage return mechanism for the spindle drive of FIG. 2A.

FIG. 5 is a section view of the spindle drive prior to a brake event.

FIG. 6 is a section view of the spindle drive during a brake event.

FIG. 7 is an exploded, section view of another example spindle drive.

FIG. 8 is a section view of the spindle drive of FIG. 7 prior to a brake event.

### DETAILED DESCRIPTION

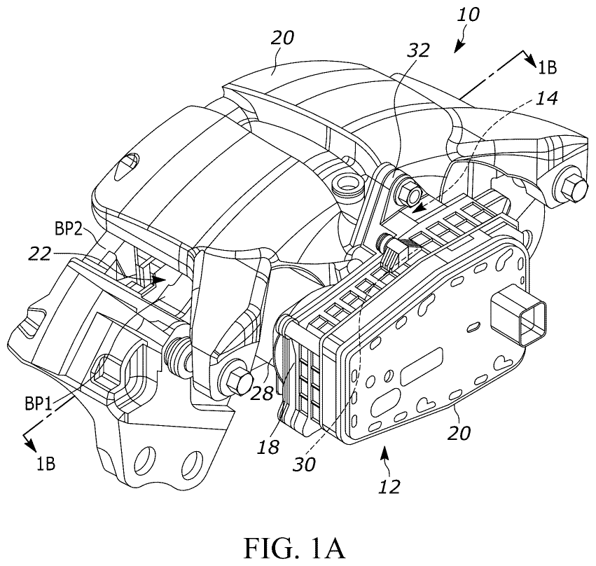

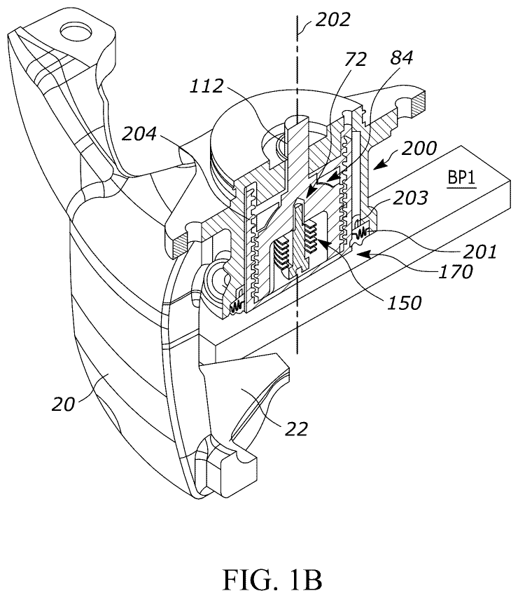

The present invention relates generally to electromechanical brakes and, in particular, relates to a non-recirculating ball-screw drive for an actuator assembly of the electromechanical brake. FIGS. 1A-1B illustrate an example actuator assembly 10 for a vehicle brake in accordance with an aspect of the invention.

The actuator assembly 10 includes a control assembly 12 and a drive assembly 14 which can be assembled as separate subunits. The control assembly 12 and the drive assembly 14 are arranged in a common housing 18 secured to a caliper housing 20. The caliper housing 20 defines a gap 22 for receiving a brake rotor (not shown). First and second brake pads BP1, BP2 are provided in the housing 20 on opposite sides of the rotor.

A motor 28 supplies torque to the drive assembly 14. To this end, the motor 28 can be coupled through a gear train 30 to the drive assembly 14 or be directly coupled to the drive assembly (not shown). As shown, a frame 32 is secured to both housings 18, 20 and supports the gear train 30. The frame 32 also helps to connect the output of the gear train 30 to the drive assembly 14 in a known manner. To this end, the drive assembly 14 includes a ball-nut assembly 72 rotatably connected to the output of the gear train 30.

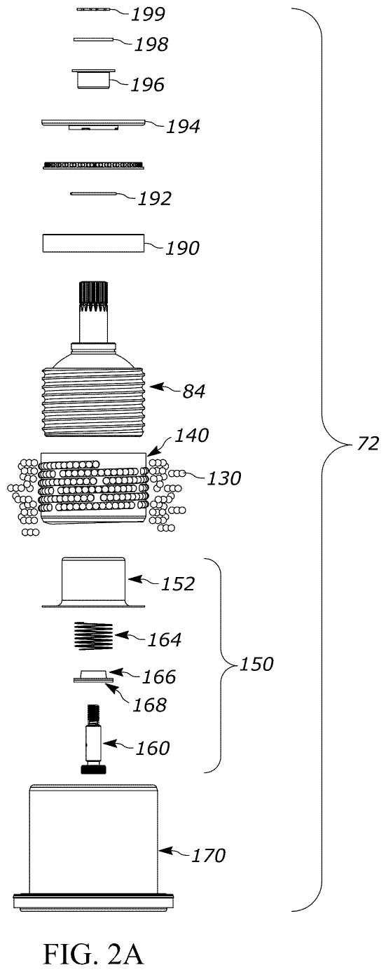

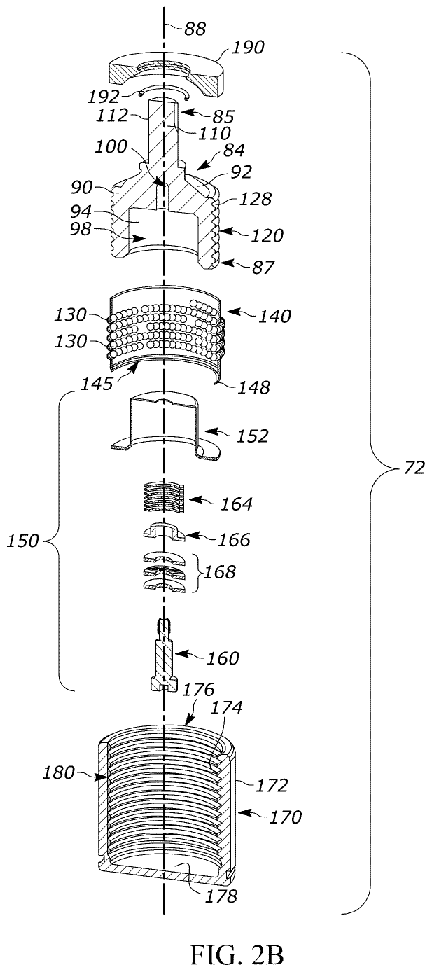

Turning to FIGS. 2A-2B the ball-nut assembly 72 includes a spindle 84 and a cooperating nut/piston 170 integrated into a single component. The spindle 84 does not contain any integrated (or machined) ball recirculating features. The spindle 84 extends along a centerline or axis 88 from a first end 85 to a second end 87. The spindle 84 includes a generally cylindrical base 90 having an outer surface 92 and an inner surface 94 defining an inner recess or pocket 98 extending from the second end 87 towards the first end 85. A threaded passage 100 extends from the recess 98 towards the first end 85.

A shaft 110 extends longitudinally from the base 90. One end of the shaft 110 includes a toothed portion 112 for connecting to the gear train 30 output in a fixed manner, e.g., a splined connection. The spindle 84 therefore rotates with the gear train 30 output. Due to this connection, the motor 28 utilizes the gear train 30 to control rotation of the ball-nut assembly 72, as will be discussed.

A spiral winding 120 is provided along the exterior of the base 90. The spiral winding 120 has a curved cross-section along its length and extends along a helical path circumferentially along the outer surface 92. The successive passes of the track winding 120 collectively define a thread 128.

Balls or bearing balls 130 are provided in the track winding 120. The bearing balls 130 can be formed from a durable material, such as metal. The cross-section of the track winding 120 is configured to ensure that the bearing balls 130 are capable of rolling freely along the length of the track winding but are limited in the ability to deviate from the centerline of the track winding. In other words, the width of the track winding 120 is large enough to accommodate the bearing balls 130 but not so large that the bearings can roll up the sides of the cross-section. Additionally, the width of the track winding 120 is large enough to accommodate the bearing balls 130 such that the bearing balls 130 can also slip/slide through the track winding at interfaces free of interference. Moreover, the depth of the track winding 130 is configured such that roughly only half the volume of the bearing balls 130 is disposed within the track winding while the remainder is positioned radially outward of the outer surface 92 of the base 90.

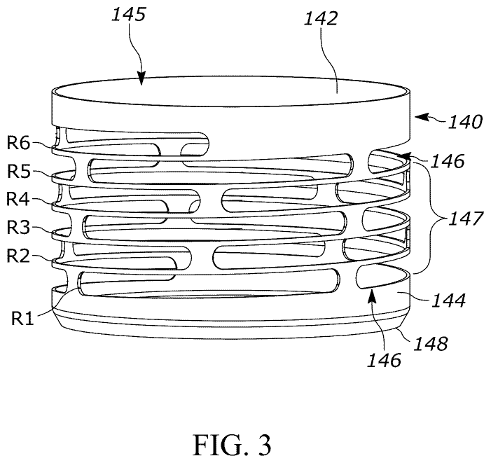

Referring to FIG. 3, a ball cage 140 is provided for the spindle 84 and has a cylindrical shape defining an inner surface 142 and an outer surface 144. The inner surface 142 defines an central passage 145. Openings 146 extend radially through the cage 140 and collectively define a track winding 147 for receiving the bearing balls 130. In particular, the openings 146 are arranged circumferentially and helically about the cage 140 in discrete openings R₁, R₂, R₃ . . . Rₙ. The openings R₁-Rₙ are discrete from one another and are arranged generally end-to-end so as to circumferentially and helically wind around the circumference of the cage 140 while advancing along the length of the cage.

That said, the helical winding of the spindle 84 and of the nut/piston 170 is the same helical winding defined by the chain of openings R₁-Rₙ that collectively define the track winding 147, which resembles the track winding 120 in the spindle 84. While the track winding 130 is continuous from one end to the other, the track winding 147 is formed from discrete, spaced-apart segments. A lip or flange 148 is provided at the bottom (as shown) of the cage 140 and extends radially inward such that the passage 145 narrows in the area of the flange. In one example, the flange 148 is frustoconical.

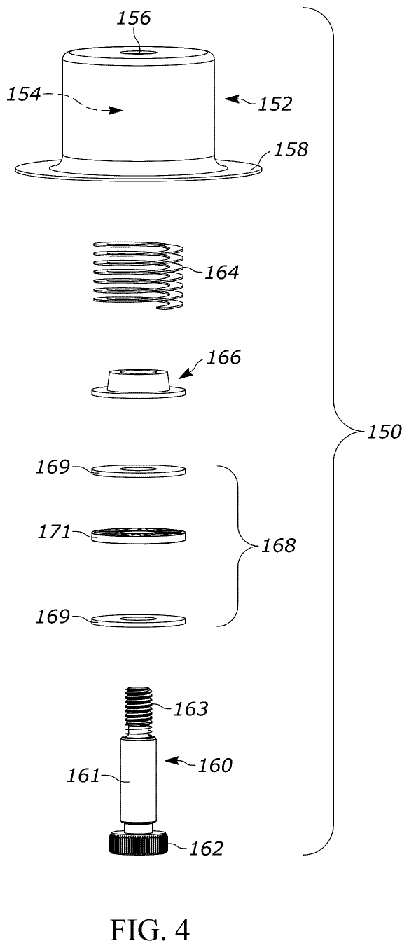

As shown in FIG. 4, the ball-nut assembly 72 further includes a cage return mechanism 150 for automatically returning the cage 140 to its initial start position once the brake is fully released such that there is no load on the bearing balls 130. In one example, the mechanism 150 includes an end cap 152 having an interior space 154 leading to a central opening 156. A flange 158 extends radially outward from the end cap 152.

An axle 160 is aligned with the end cap 152 and includes a longitudinally extending shaft 161 extending from a head 162. The shaft 161 terminates at a reduced diameter threaded portion 163. A compression spring 164, spacer 166, and thrust bearing assembly 168 are provided within the end cap. The thrust bearing assembly 168 includes one or more washers 169 and a needle 171.

The nut 170 is cylindrical and includes an outer surface 172 and an inner surface 174 defining a central passage 176. The central passage 176 extends along the length of the nut 170 and terminates at an end wall 178. That said, the nut 170 is closed at one end. A track winding 180 is provided along the inner surface 174 and can exhibit, for example, a helical pattern, mirroring the contour of the track winding 120 on the spindle 84.

Additionally, the width of the track winding 180 is large enough to accommodate the bearing balls 130 such that the bearing balls 130 can also slip/slide through the track winding at interfaces free of interference. Moreover, the depth of the track winding 180 is configured such that roughly only half the volume of the bearing balls 130 is disposed within the track winding while the remainder is positioned radially inward of the inner surface 174. In will be appreciated that the nut 170 could also be called the piston 170 because it performs the function of a piston in a brake caliper.

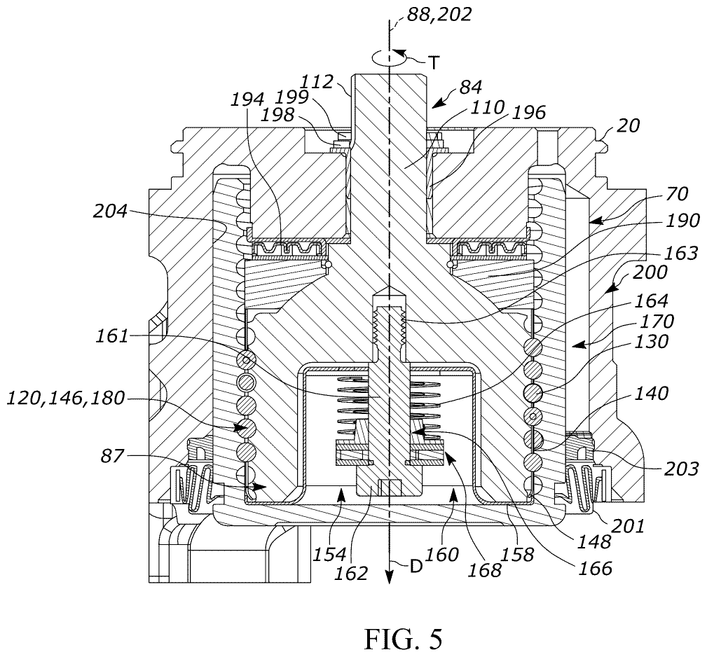

FIG. 5 illustrates the fully assembled ball-nut assembly 72 in which the nut 170 is positioned over the spindle 84 such that the tracks 120, 180 are radially aligned with one another. The bearing balls 130 are positioned in and between the tracks 120, 180 and are capable of rolling as well as sliding within the tracks 120, 180. The cage 140 is positioned radially between the tracks 120, 180 with the bearing balls 130 positioned in the openings 146 and extending to opposite sides of the cage wall.

A spherical washer 190 extends over the outer surface 92 of the base 90 adjacent the shaft 110. A retaining ring 192 (see FIG. 2B) can optionally be provided to help secure the spherical washer 190 to the base 90. The spherical washer 190 extends radially outward sufficient to engage the top of the cage 140. A thrust bearing 194 is positioned axially between the housing 20 spherical washer 190. A flanged bearing sleeve 196 is positioned in the housing 20 and receives the shaft 110 of the spindle 84. The sleeve 196 is held in place by a ring spacer 198 and a retaining ring 199.

The base 90 of the spindle 84 is positioned within the central passage 176 of the nut 170. The end cap 152 is positioned within the pocket 98 with the opening 156 aligned with the threaded passage 100. The threaded portion 163 of the axle 160 extends through the opening 156 and forms a threaded connection with the threaded passage 100. The thrust bearing assembly 168 extends over the shaft 161 and engages the head 162. The spacer 166 slip fits over the shaft 161 and engages the thrust bearing assembly 168.

The compression spring 164 encircles the shaft 161 and is axially bound by the spacer 166 and the underside of the cap 152. The axle 160 is tightened into the threaded passage 100 so that the axle 160 is fixed solidly to the spindle 84. The spring 164, the spacer 166, the length of the shaft 161, and the depth of end cap 152 are all designed to the dimensions needed to achieve the level of spring 164 compression that is necessary to automatically return the cage 140 along with the installed bearing balls 130 to the home position when the brake is fully released.

The flange 148 on the ball cage 140 extends between the bottom thread 128 of the spindle 84 and the flange 158 of the end cap 152. In this state, the flange 148 on the ball cage 140 can engage the flange 158 or be spaced therefrom. Regardless, the flange 148 on the ball cage 140 extends to a position radially overlapping the flange 158 on the end cap 152.

Referring further to FIG. 1B, the ball-nut assembly 72 extends through a sleeve 200 defined by the housing 20 and is aligned with/adjacent to the first brake pad BP1. The toothed portion 112 is rotatably coupled to the gear train 30 to enable torque transmission therebetween. With this in mind, the ball-nut assembly 72 is configured such that rotation of the spindle 84 results in axial movement of the nut 170 along an axis 202 and along an inner, cylindrical running surface 204 of the sleeve 200. Axial movement of the nut 170 controls movement of the first brake pad BP1 towards and away from the rotor. A piston boot/excluder 201 and piston seal 203 are provided radially between the nut 170 and the inner surface 204.

The sleeve 200 and the nut 170 can be provided with anti-rotation features that cooperate to prevent rotation of the nut relative to the sleeve, thereby allowing movement of the nut along [not about] the axis 202. In one example, the caliper housing 20 includes an axially extending slot 70 that cooperates with a key (not shown) fixed to an movable with the nut 170. With that said, the spindle 84 and the nut 170 have an advantageous, cooperative configuration that helps maximize the efficiency in converting rotation of the spindle 84 to axial movement of the nut 170.

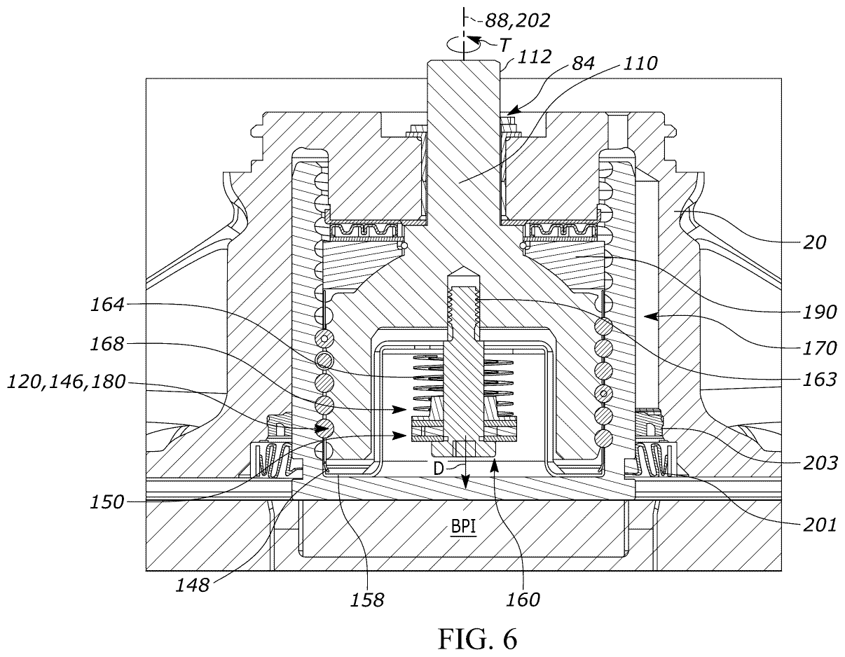

In operation, and referring to FIG. 6, the vehicle operator depresses the brake pedal (not shown) or the vehicle autonomously initiates a braking operation. In either case, the vehicle controller actuates the motor 28, which ultimately delivers torque to the toothed portion 112 of the ball-nut assembly 72. The spindle 84 rotates about the axis 202 in the manner T (counterclockwise as shown) but is prevented from translating axially along the axis.

Rotation of the spindle 84 in the manner T causes the nut/piston 170 to translate along the axis 202 in a direction D away from the spindle 84 and towards the first brake pad BP1. Continued rotation of the spindle 84 in the manner T ultimately causes the nut 170 to engage the first brake pad BP1 and move the first brake pad against the brake rotor in the direction D. In response to the reaction forces acting inside the actuator assembly 10 and the housing 20, and the force acting on the first brake pad BP1, the second brake pad BP2 is also forced onto the brake rotor to thereby brake the vehicle.

As the nut 170 moves towards the first brake pad BP1 in the direction D, both the cage 140 and the bearing balls 130 travel axially with the nut 170 in the direction D relative to the spindle 84. More specifically, the cage 140 travels axially with the nut 170 away from its initial or start position abutting the washer 190, thereby disengaging the same. At the same time, both the cage 140 and the bearing balls 130 travel/rotate with the spindle 84 in the direction T. Due to rolling of the bearing balls 130 as clamp force is generated, the motion of the cage 140 and the bearing balls 130 relative to the spindle 84 and nut 170 is, in one example, about half the rotation of spindle 84 and half the axial stroke of the nut 170, respectively.

Axial movement of the cage 140 with the nut 170 causes the flange 148 to push the flange 158 on the end cap 152 against the bias of the spring 164. As the flange 148 of the cage 140 pushes on the flange 158, both the cage 148 and the end cap 152 travel together without relative movement therebetween due to the thrust bearing 168 (which accommodates rotation with minimal opposing torque) and the spring 164 (which accommodates axial stroke). Eventually, the spring 164 bias is overcome and the end cap 152 moves axially from its initial/start position relative to the spindle 84, thereby compressing the spring 164 between the end cap 152 and the spacer 166 and creating a gap between the end cap flange 158 and the spindle 84. That said, applying the brakes loads the cage return mechanism 150.

During axial translation of the nut 170 along the spindle 84, the bearing balls 130 are forced to travel through the respective track windings 120, 180 while maintaining connection with the spindle 84. To the end, the bearing balls 130 have fixed positions relative to the cage 140 but rotate within the openings 146 as the spindle 84 rotates and the nut 170 axially translates. The bearing balls 130 are journalled with play between the spindle 84 and the nut 170 to facilitate relative movement between the spindle and nut.

That said, at relatively low clamp loads, while the spring 164 bias load has not been achieved via the load developed at the cage 140 and the end cap 152 the bearing balls 130 have a sliding friction interface with the track windings 180. As the load on the bearing balls 130 increases due to encountering the load to slide the piston 170 and/or clamp load increases to the point that the spring 164 bias is overcome, the bearing balls 130 transition to a rolling friction interface with the track windings 120, 180. At the same time, the conical/frustoconical interface between the flanges 148, 158 helps to prevent relative rotation therebetween during brake application, i.e., as long as brake force is applied. Consequently, the interface between the flanges 148, 158 allows the compression spring 164 to become and stay loaded so long as the brakes are applied to some minimal degree. In particular, the reaction forces generated by applying the brakes are sufficient to bias the flange 158 into engagement with the flange 148 in a manner that prevents relative rotation therebetween.

The motor 28 rotation is stopped when the desired clamp force is generated on the rotor. In this case, the motor 28 is still powered and the desired clamp force is maintained as the vehicle decelerates at a rate desired by the vehicle driver or by the autonomous system controlling the vehicle.

To thereafter release the clamp force, the motor 28 is commanded to rotate in the opposite direction (a direction opposite the direction T) at a rate desired by the vehicle driver or autonomous system. As the clamp force is reduced, at a predetermined low clamp force, the spring 164 contains sufficient load to force the cage 140 and bearing balls 130 via the end cap 152 to slide back to the home or start position abutting the end cap 152 to the spindle 84. More specifically, the spring 164 bias at said predetermined low clamp force is now great enough to overcome the frictional forces between the bearing balls 130 and the track windings 120, 180 to force the cage 140 and bearing balls 130 to slide back to the home or start position.

This predetermined low clamp force also coincides with an instance when reaction forces from the clamp force are lower than the compression spring force, allowing the compression spring 164 to expand and thereby push the cage 140 [via contact at the flanges 148, 152], which causes the cage to rotate towards its home position. In particular, since the spacer 166 has a fixed position relative to the spindle 84, the spring 164 automatically expands upwards (as shown) to push the end cap 152 towards the spindle 84 [in a direction opposite the direction D] and reduce the gap. As the end cap 152 moves towards the spindle 84, the flange 158 pushes the cage 140 and bearing balls 130 back towards the start position shown in FIG. 5.

It will be appreciated that since the flange 158 extends radially beyond the flange 148 on the cage 140, the direction of force by the flange on the cage is parallel and evenly distributed around the axis 88 of the spindle 84. It other words, the cage return mechanism 150 does not exert lateral (in this case radially directed) forces on the cage 140 during the return trip of the cage to the start position. This ensures that the cage 140 maintains a uniform or substantially uniform radial spacing between the spindle 84 and the nut 170, thereby maximizing the efficiency of the bearing balls 130 to roll within the track windings 120, 180 and return the cage to the start position.

Additionally, at said predetermined low clamp force, the bearing balls 130 roll within the track windings 120, 180 but since the spindle 84 and nut 170 are stationary the cage 140 is caused to rotate about the axis 202 relative to both the spindle 84 and the nut 170. The spring 164 expands to rotate the cage 140 until the flange 158 of the end cap 152 abuts the second end 87 of the spindle 84 to return the cage and bearing balls 130 to the start position of FIG. 5. In other words, stopping the brake application below the predetermined low clamp force causes/allows the cage return mechanism 150 to unload and automatically return the cage 140 back to its initial position.

Once the braking operation is complete, the motor 28 is rotated in the opposite direction to thereby rotate the spindle 84 in the direction opposite the direction T (clockwise as shown). It is understood that by operating the motor 28, the nut 170 is moved into a retracted position which is associated with lifting the first brake pad BP1 and the second brake pad BP2 off the brake rotor.

It will be appreciated that as the brake pads BP1, BP2 wear over time the distance between the end of the nut 170 and its first brake pad BP1 would normally increase over time. Since the nut 170 has a finite degree of stroke relative to the spindle 84, e.g., from about 5 mm up to about 7 mm, the efficacy of the spindle assembly 74 in braking the vehicle would be reduced over time without in-use adjustments.

With this in mind, the position to which the nut/piston 170 returns will automatically adjust over time. In particular, as the brake pad(s) BP1, BP2 wear, the return position of the nut 170 will drift/shift in the direction towards the brake pad to ensure that the travel distance needed to apply the brake is constant or substantially constant over time. This shift is accomplished by, for example, sensing the feedback current of the motor 28 and adjusting its retraction accordingly. As the motor 28 completes its retraction target, the load at the first brake pad BP1 specifically is reduced to essentially zero as described in previous paragraphs, and thus, the cage 140 and integrated bearing balls 130 are repositioned to the start position due to the preloaded spring 164.

That said, due to the interaction between the cage return mechanism 150 and the cage 140, the cage is returned to the same start position regardless of any shifting of the nut 170. The specific positions of the bearing balls 130 within the track winding 120 prior to braking would change to account for the axial movement of the nut 170 relative to the cage 140 accounting for brake pad wear. In other words, operation of the cage return mechanism 150 is unchanged during the life of the brake pads BP1, BP2.

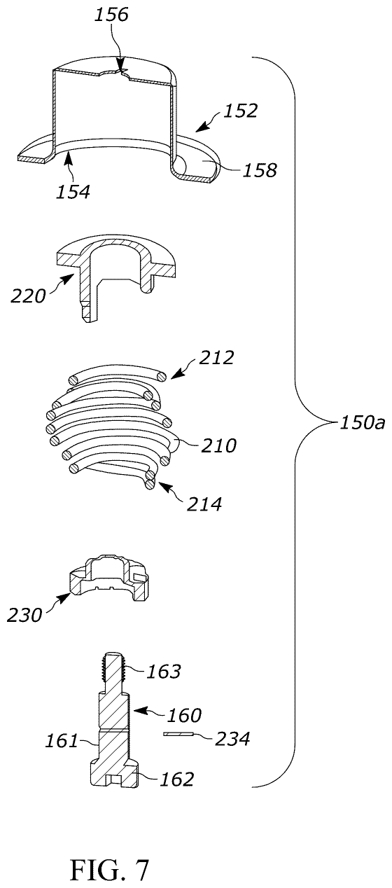

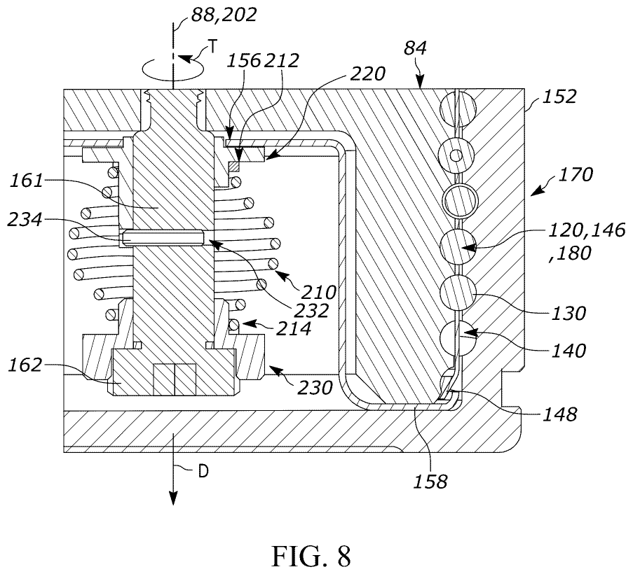

A second configuration for the cage return mechanism 150a is shown in FIGS. 7-8. In FIGS. 7-8, the biasing member is configured as a combination torsion spring/compression spring 210 having a first end 212 secured to bearing 220 and a second end 214 connected to a support member 230. Both the bearing 220 and the support member 230 extend over the shaft 161. The bearing 220 extends through the opening 156 in the end cap 152 and downward along the shaft 161. A pin 234 extends through an opening 232 in the shaft 161 and abuts the bearing 220 to prevent rotation of the bearing relative to the shaft in one direction but allow for rotation of the bearing relative to the shaft in the opposite direction in order to load the spring 210 during braking operations. The pin 234 also helps to support the preload torque from the torsion spring 210.

The bearing 220 is configured to support side loads generated by loading the torsion spring 210 during brake application. The bearing 220 also helps to maintain the torsion spring 210 concentric with the shaft 161 of the axle 160. The support member 230 is splined to the head 162 of the axle 160 to prevent relative rotation between. That said, the ends 212, 214 of the torsion spring 210 are held by the respective components 220, 230.

During brake apply, the spindle 84 rotates together with the axle 160 and support member 230 in the manner T to advance the nut 170 in the direction D and thereby apply the brake pad BP1 to the rotor. To this end, as noted the end cap 152 is preloaded against the end of the spindle 84 and, thus, rotation of the spindle will also be experienced by the end cap 152. With this in mind, at the start of brake apply, the components 84, 152, 162, 230, 220, and 210 will all rotate together. If there is slight axial clearance between flanges 148, 158, then there will be some rotation of the balls 130 and advancing of the cage 140 until there is contact between the flanges.

When contact is made between the flanges 148, 158, the cage 140 is prevented from rotating, which thereby prevents rolling of the balls 130 within the windings 120, 180. In turn, this will force sliding between the balls 130 and the piston/nut 170 until the load on the nut reaches a predetermined amount at which time the balls will begin to roll. In particular, the balls 130 will roll when the nut 170 movement is resisted by a sufficient force to force the balls to be “squeezed” between the windings 120, 180 of the spindle 84 and piston 170. When that load is high enough (the predetermined amount is reached), sliding is no longer possible and the balls 130 will roll. When the balls 130 roll, the cage 140 has to move to allow the balls 130 to roll along the winding surface 120, 180 to a new position.

Up until the balls 130 begin to roll, the end cap 152 has no relative motion to the spindle 84. As the balls 130 begin to roll, however, the cage 140 rotation will be slowed down compared to the spindle 84—the cage will lag behind. Since the cage 140 rotation is slower than the spindle 84, and the cage is connected to the spring support 220, the spring support will also have a slower rotational velocity than the spindle 84. This difference in velocity will cause the torsion spring 210 to increase in potential energy. In other words, the second end 214 of the torsion spring 210 is wound tighter relative to the first end 212, thereby loading the torsion spring as clamp force is generated between the brake pads BP1, BP2.

At the same time, the ball cage 140 pushes the flange 158 of the end cap 152 in the direction D thereby axially moving the bearing 220 and first end 212 of the torsion 210 towards the brake pad BP1 and relative to the axle 160 and support member 230.

As with the earlier example, rotation of the motor 28 in this example is stopped when the desired clamp force is generated on the rotor. In this case, the motor 28 is still powered and the desired clamp force is maintained as the vehicle decelerates at a rate desired by the vehicle driver or by the autonomous system controlling the vehicle.

To thereafter release the clamp force, the motor 28 is commanded to rotate in the opposite direction (a direction opposite the direction T) at a rate desired by the vehicle driver or autonomous system. As the clamp force is reduced, at the predetermined low clamp force in which the load on the bearing balls 130 falls toward zero, the torsion spring 210 contains sufficient load to force the cage 140 and bearing balls 130 via the end cap 152 to slide back to the home or start position in which the end cap 152 abuts the spindle 84. More specifically, the spring 210 bias is great enough to overcome the frictional forces between the bearing balls 130 and the track windings 120, 180 to reposition the cage 140 and bearing balls 130 to their home or start position.

Since the support member 230 has a fixed position relative to the spindle 84, the torsion spring 210 automatically expands/unwinds upwards (as shown) to push the end cap 152 towards the spindle 84 and reduce the gap. As the end cap 152 moves towards the spindle 84, the flange 158 pushes the cage 140 and bearing balls 130 back towards the start position.

It will be appreciated that since the flange 158 extends radially beyond the flange 148 on the cage 140, the direction of force by the flange on the cage is parallel to the axis 88 of the spindle 84. It other words, the cage return mechanism 150a does not exert lateral (in this case radially directed) forces on the cage 140 during the return trip of the cage to the start position. This ensures that the cage 140 maintains a uniform or substantially uniform radial spacing between the spindle 84 and the nut 170, thereby maximizing the efficiency of the bearing balls 130 to roll within the track windings 120, 180 and return the cage to the start position.

Furthermore, it will be appreciated that the conical/frustoconical interface between the perimeters/extents of the flanges 158 helps to ensure that the two components are fixed to each other as long as a clamp load is present at the first brake pad BP1. That said, the interface ensures that the components 148, 158 do not move relative to one another during brake apply, thereby ensuring transfer of torsional and axial forces so that the torsion spring 210 can become and stay loaded during brake apply in order to ultimately, automatically return the cage 140 to its start position when the brake is released, i.e., when the clamp load drops to zero.

Additionally, at said predetermined low clamp force, the bearing balls 130 roll within the track windings 120, 180 but since the spindle 84 and nut 170 are stationary the cage 140 is caused to rotate about the axis 202 relative to both the spindle 84 and the nut 170. The torsion spring 210 expands to rotate the cage 140 until the flange 158 of the end cap 152 abuts the second end 87 of the spindle 84 to return the cage and bearing balls 130 to the start position. In other words, stopping the brake application causes/allows the cage return mechanism 150a to unload and automatically return the cage 140 back to its initial position.

Once the braking operation is complete, the motor 28 is rotated in the opposite direction to thereby rotate the spindle 84 in the direction opposite the direction T (clockwise as shown). It is understood that by operating the motor 28, the nut 170 is moved into a retracted position which is associated with lifting the first brake pad BP1 and the second brake pad BP2 off the brake rotor.

It will be appreciated that in both configurations of the biasing member, the degree to which the biasing member is pre-loaded can be adjusted. In the example shown in FIGS. 5-6, the thickness (in the direction D) of the spacer can be adjusted to vary the degree to which the compression spring is preloaded. In the example shown in FIGS. 7-8, the splined connection between the support member and head of the axle allows the rotational position of the support member to be set/adjusted prior to braking. Consequently, the degree to which the torsion spring is preloaded can be selected by choosing which splines on the mating components engage one another.

The present invention is advantageous in that the track windings and bearing balls are specifically sized and configured to precisely dictate when during the braking operation the cage return mechanism can automatically return the cage to its home or start position. To this end, specifically sizing the bearings to have slightly smaller diameters than the diameter of each track winding it rolls/slides in ensures that the bearing balls are unloaded precisely when the braking force is removed (or reaches a predetermined, nominal amount). In particular, the bearing balls are permitted to roll and to slide within the track windings during brake apply or during brake release events. This helps to ensure the cage return mechanism quickly returns the cage to its home position precisely when load on the bearing balls 130 is reduced to essentially zero load as the brake is released.

Additionally, current non-recirculating ball nut assemblies (nrBNA) are preloaded sufficient to slide the piston with up to 100 or 200N braking force during an apply event. This occurs because the piston in these nrBNA designs can only axially stroke a maximum of about 2.0 mm under load and, thus, clamp force must be immediately applied once the balls begin rolling otherwise most/all of the piston stroke is “wasted” taking up the air gap. In other words, the short stroke of the piston in these current nrBNA designs necessitates a relatively large preload force to begin brake apply as quickly as possible during the stroke.

On the other hand, the much longer loaded stroke (balls rolling stroke) of the nrBNA of the present invention (e.g., up to about 7 mm) means that the cage is preloaded at a much lower level-primarily to reset the cage after an apply event. In other words, the preload is not configured to help apply braking force quickly but rather to simply reset the cage when desired. Consequently, the cage preload in the present invention can be much lower than that needed in current nrBNAs. Along the same lines, the much larger loaded stroke in the present invention allows the nrBNA to transition into the ball rolling stroke almost immediately during a brake apply event because the long stroke of 7 mm can accommodate the gap between the pads and rotor and still have more than sufficient stroke to apply high clamp loads.

The present invention is also advantageous in that replacing the standard recirculating spindle assembly with a non-recirculating configuration increases the mechanical efficiency of the spindle assembly. In particular, the cage return mechanism does not exert side loads on the ball cage during brake application or release, as well as the elimination of any metal to metal slip friction, thereby reducing drag loss and minimizing the loss in efficiency. To this end, using the cage and bearing balls removes/prevents any direct contact between the spindle and the nut as well as between the cage and either the spindle or the nut-all relative rotation between the components occurs though the bearing balls. Moreover, the ball return/recirculating features normally present can be omitted.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A ball-nut assembly for an actuator assembly of a vehicle brake, comprising:
a spindle rotatable about an axis and including an exterior track winding extending around the spindle and an inner recess extending axially into the spindle;
a piston integrated with a nut including an interior track winding and being positioned over the spindle so as to be movable along the axis in response to rotation of the spindle for applying the vehicle brake;
a cage provided between the track windings and including openings for receiving bearing balls sized to at least one of roll and slip interference free within the track windings; and
a cage return mechanism provided in the inner recess of the spindle, wherein the cage moves axially and rotationally from a start position in a first direction with the nut relative to the spindle in response to brake application to load the cage return mechanism, and wherein in response to releasing the brake the cage return mechanism unloads to automatically move the cage in an opposite second direction back to the start position.

2. The ball-nut assembly as recited in claim 1, wherein the cage return mechanism comprises:
an end cap provided in the inner recess of the spindle;
a biasing member for biasing the end cap towards the spindle;
a thrust bearing for allowing generally free rotation of the end cap, and
an axle for coupling the end cap and the biasing member to the spindle, wherein in response to brake application the cage moves the end cap in the first direction against the biasing force of the biasing member, and wherein in response to releasing the brake the biasing member automatically moves the end cap in the second direction to return the cage to the start position.

3. The ball-nut assembly as recited in claim 2, wherein the biasing member comprises a compression spring.

4. The ball-nut assembly as recited in claim 2, wherein the biasing member comprises a torsion spring.

5. The ball-nut assembly as recited in claim 4, wherein the cage return mechanism further comprises:
a support member fixed to the axle and receiving a first end of the torsion spring; and
a bearing movable with the end cap relative to the axle and receiving a second end of the torsion spring.

6. The ball-nut assembly as recited in claim 5, wherein the axle is threaded into the spindle and the biasing member encircles the axle.

7. The ball-nut assembly as recited in claim 5, wherein the support member and axle having a splined connection allowing for adjustment of a pre-load on the torsion spring.

8. The ball-nut assembly as recited in claim 2, wherein the end cap includes a flange that interfaces with a flange on the cage to prevent relative rotation therebetween during brake application.

9. The ball-nut assembly as recited in claim 8, wherein the flanges are frustoconical.

10. The ball-nut assembly as recited in claim 2, wherein the end cap includes a base provided in the inner recess and a flange extending radially outward to an end surface of the spindle for engaging the cage.

11. The ball-nut assembly as recited in claim 1, wherein the bearings do not-recirculate within the track windings.

12. The ball-nut assembly as recited in claim 1, wherein the bearing balls have a slip interface with the track windings when a load on the piston is below a predetermined amount and have a roll interface with the track windings once the load on the piston reaches the predetermined amount.

13. The ball-nut assembly as recited in claim 11, wherein the piston has a single stroke axial movement of up to 7 mm per each brake apply event. The ball-nut assembly as recited in claim 11, wherein the cage return mechanism does not contribute to applying the brake before the bearing balls begin the roll interface with the track windings.

14. A ball-nut assembly for an actuator assembly of a vehicle brake, comprising:
a spindle rotatable about an axis and including an exterior track winding extending around the spindle and an inner recess extending axially into the spindle;
a piston integrated with a nut including an interior track winding and being positioned over the spindle so as to be movable along the axis in response to rotation of the spindle for applying the vehicle brake;
a cage provided between the track windings and including a flange and openings for receiving bearing balls sized to at least one of roll and slip interference free within the track windings;
a cage return mechanism provided in the inner recess of the spindle, comprising:
an end cap having a base provided in the inner recess of the spindle and a flange extending radially outward to an end surface of the spindle for interfacing with the flange on the cage to prevent relative rotation therebetween during brake application and a flange;
a biasing member for biasing the end cap towards the spindle;
a thrust bearing for allowing generally free rotation of the end cap; and
an axle secured to the spindle for coupling the end cap and the biasing member to the spindle, wherein the cage moves axially and rotationally from a start position in a first direction with the nut relative to the spindle in response to brake application to load the cage return mechanism, and wherein in response to releasing the brake the cage return mechanism unloads to automatically move the cage in an opposite second direction back to the start position.

15. The ball-nut assembly as recited in claim 14, wherein the biasing member comprises a compression spring.

16. The ball-nut assembly as recited in claim 14, wherein the biasing member comprises a torsion spring.

17. The ball-nut assembly as recited in claim 14, wherein the cage return mechanism further comprises:
a support member fixed to the axle and receiving a first end of the torsion spring; and
a bearing movable with the end cap relative to the axle and receiving a second end of the torsion spring.

18. The ball-nut assembly as recited in claim 17, wherein the support member and axle having a splined connection allowing for adjustment of a pre-load on the torsion spring.

19. The ball-nut assembly as recited in claim 17, wherein the flanges are frustoconical.
